(19) United States
(12) Patent Application Publication
(10) Pub. No.: US 2010/0100703 A1
(43) Pub. Date: Apr. 22, 2010

(54) System For Parallel Computing

(75) Inventors: Chandan Basu, Pune (IN); Mandar Nadgir, Mumbai (IN); Avinash Pandey, Pune (IN)

Correspondence Address: FRISHAUF, HOLTZ, GOODMAN & CHICK, PC, 220 Fifth Avenue, 16TH Floor, NEW YORK, NY, 10001-7708, US

(73) Assignee: Computational Research Laboratories Ltd., Pune (IN)

(21) Appl. No.: 12/579,544

(22) Filed: Oct. 15, 2009

(30) Foreign Application Priority Data
Oct. 17, 2008 (IN) 2237/MUM/2008

(51) Int. Cl. G06F 15/80; G06F 9/06; G06F 9/46

(52) U.S. Cl. 712/11; 719/313; 712/16; 712/E09.003

(57) ABSTRACT

A system and a method for parallel computing for solving complex problems is envisaged. Particularly, hierarchical parallel computing system is envisaged by this invention, which is formed by multiple levels of groups, where each group consists of multiple processing elements. Each group of the parallel computing system models as processing element to its immediate upper layer. Thus, each processing element is hierarchically tagged to its immediate upper level, and a multi-level tier of groups are formed. In accordance with this invention, the parallel computing system operates by breaking any problem hierarchically, first across the groups and then within the groups. This hierarchical breakup of the problem helps in significantly improving the time required for processing a problem.

### CROSS-REFERENCE TO RELATED APPLICATION

The present application claims priority under 35 USC 119 of Indian Patent Application 2237/MUM/2008 filed Oct. 17, 2008, the entire disclosure of which is incorporated herein by reference.

### FIELD OF THE INVENTION

The present invention relates to the field of computing.

Particularly, the present invention relates to the field of parallel computing.

### DEFINITIONS OF TERMS USED IN THE SPECIFICATION

Group: A Group is a collection of processing elements in a parallel computing system.

Interconnect network: A interconnect network is a communication link which connects the nodes in a parallel computing system based on a predetermined network topology.

Inter-group Communication: Inter-group communication is the communication that takes place between two or more processing elements across groups of a parallel computing system.

Intra-group Communication: Intra-group communication is the communication that takes place between two or more processing elements within a group of a parallel computing system.

Message Passing Interface: Message Passing Interface (MPI) is a communication standard which facilitates communication between multiple processing elements.

Network: A Network is a physical link i.e. an interconnect network connecting two or more nodes or a circuit which connects two or more processing elements within a node.

Node: A node is a set of processing elements and having its own memory.

Processing Element (PE): A processing element is the smallest computing unit that executes a stream of instructions. A processor element can be a core/processor/workstation/computer connected to a node.

Shared hardware resource information: Shared hardware resource information is the information about the hardware including the processing elements that share the same memory or are placed on the same node, nodes that are connected to the same switch and the like.

Topology: Topology is a specific arrangement of nodes in a network.

Speed-up: The ratio of time taken to compute same problem with n (>1) processors to the time taken to compute using a single processor.

Scaling: The ability to compute larger problem with more processors in the same time is called scaling of a problem.

### BACKGROUND OF THE INVENTION

Parallel computing is a form of computation in which many processing elements are interconnected to simultaneously solve larger problems. Typically, the problem is divided into smaller ones and distributed amongst the processing elements to concurrently carry out the calculations and solve the problems faster.

The problems solved by the parallel computing system are typically, divided into two broad categories based on the type of computing requirement namely Type-A and Type-B. The Type-A computing requirements are based on solving bigger problems like scientific problems, grand challenge problems and benchmarking studies efficiently, whereas Type-B computing requirements are based on solving problems like engineering problems and practical problems faster. For Type-A problems there exists very powerful supercomputers, however for applications based on Type-B problems there is dearth of scalable, efficient and fast parallel computing systems.

With the advent of multi-core CPUs and fast interconnects, the computing power of supercomputers is increasing very fast. The computational problems in science and engineering are becoming increasingly more complex. To solve these complex problems parallel computation on large supercomputers is becoming common nowadays. Parallel computation works on the premise that large complex problems can be broken down into smaller problems. These smaller problems can be (1) distributed on processing units, (2) be worked upon independently for certain amount of time, (3) then collated later on. The steps (1) to (3) are repeated till final result of the larger problem is obtained.

Parallel programming techniques are used as a means to improve the performance and efficiency of parallel computing systems. The parallel programs break up the processing into parts, each of which can be executed concurrently and at the end the results of concurrent processing are put together again to get a final result. However, the parallel programming techniques are becoming more complex and require more speed and computing power.

However, the speedup of many parallel applications on large supercomputers is often not satisfactory. One of the main reasons for poor scaling of parallel applications is the distribution of the whole job amongst available nodes at a single level. This leads to random communication across the interconnect network causing congestion and delay as seen in FIG. 1 of the accompanying drawings. FIG. 1 illustrates a typical parallel computing system of the prior art for solving a problem. The nodes [as represented by the dots] form the core of the computing system. The arrows represent the communication between said nodes [as represented by the dots]. The overall communication pattern is random and not optimized in relation to distribution of nodes, and hence leads to lesser efficiency.

There have been attempts in the prior art to overcome these problems and achieve efficient and congestion free utilization of the interconnect network.

Particularly, US Patent Application 2009/0240915 discloses an arrangement for a parallel computer and a method for broadcasting collective operation contributions throughout a parallel computer using parallel algorithms. The parallel computer is formed by interconnecting a plurality of computer nodes. The parallel computer performs communication at two levels intra node and inter node. Each compute node and the plurality of processors attached to the compute node have a single designated network link assigned to them and in addition, each processor is assigned a position for that network link domain.

However, US Patent Application 2009/0240915 performs the distribution of the processes at the node level; hence the parallel computer doesn't scale well and take longer time for processing as data movement between the nodes is high.

Further, EP Patent Application 1293902 discloses the concept of grouping plurality of processors of a parallel computer system connected via a network into groups. The patent application consists of input, communication processor and output. The input entered by the operator consists of the groups and the processors belonging to the groups. In addition, the input also specifies the logical group and processor numbers along with the starting points and end points of the X axis co-ordinate and the Y axis coordinate of each group. A network is formed along the X-axis and Y-axis and the processors are arranged as a matrix by the X-axis and Y-axis networks. The processors communicate in two stages namely intra-group communication and inter-group communication. The intra-group communication is performed using the logical processor number within a group and the inter-group communication is performed using the logical number of the groups.

Although, the EP Patent Application 1293902 aims at providing an efficient congestion free interconnect network, the patent application is restrictive as the network is configured like a matrix and uses X and Y co-ordinates thus, the patent application cannot be easily ported onto existing parallel network setups. In addition, the patent application requires human intervention by way of providing input like the group division information. Furthermore, the groups are formed based on the data processing needs thus requiring re-configuration of the group division information.

There is therefore, a need for a parallel computing system that efficiently uses the interconnect network efficiently and makes the processing of the problem faster. Furthermore, there is a need for a generic system which forms the groups/ ‘interconnect structures’ independent of the desired data processing and which is easily scalable for solving problems for Type A and B based applications.

### OBJECT OF THE INVENTION

It is an object of this invention to provide a system for parallel computing which uses the interconnect network efficiently.

It is another object of this invention to provide a system for parallel computing which solves problems faster.

It is yet another object of this invention to provide a system for parallel computing which can be applied to existing parallel computing systems.

It is still another object of this invention to provide a system for parallel computing in which the grouping of processing elements is independent of the desired data processing.

Another object of this invention is to provide a scalable parallel computing system.

### SUMMARY OF THE INVENTION

The present invention envisages a system for parallel computing for solving complex problems, said system comprising:
hierarchical groups of processing elements;
network adapted to connect each processing elements in a group to at least one other processing element in the group and at least one processing element in a group to at least one other processing element in another group;
unique identification means adapted to assign a unique intra-group rank to each of said processing elements within the groups and a unique inter-group rank to each of said groups;
communication means adapted to provide intra-group and inter-group communication in said network;
storage means adapted to store the ‘shared hardware resource’ information, details of the network topology and the complex problem;
inputting means adapted to receive said ‘shared hardware resource’ information, network topology details and the complex problem from said storage means;
a distribution means co-operating with the communication means and the inputting means, adapted to distribute said complex problem amongst the groups and the processing elements within the groups for determining a solution by said processing elements;
receiving means adapted to receive the solution chunks from said processing elements; and
collating means adapted to receive and collate said solution chunks and further adapted to provide a complete solution for said complex problem.

Particularly, the communication means is further adapted to provide intra-group communication using point to point and collective communication within the group using Message Passing Interface (MPI).

Still particularly, communication means is still further adapted to provide inter-group communication between each processing element in a group and its peer processing element in another group using MPI.

In accordance with this invention, there is provided a method for parallel computing for solving complex problems, said method comprising the following steps:
a. creating a hierarchical groups of processing elements;
b. forming a network adapted to connect each processing elements in a group to at least one other processing element in the group and at least one processing element in a group to at least one other processing element in another group;
c. assigning a unique intra-group rank to each of said processing elements within the groups and a unique inter-group rank to each of said groups;
d. providing intra-group and inter-group communication in said network;
e. storing the ‘shared hardware resource’ information, details of the network topology and the complex problem;
f. receiving said ‘shared hardware resource’ information, network topology details and the complex problem from said storage means;
g. distributing said complex problem amongst the groups and the nodes within the groups for determining a solution by said processing elements;
h. receiving the solution chunks from said processing elements; and
i. collating said solution chunks to provide a complete solution for said complex problem.

Specifically, the step of providing intra-group and inter-group communication includes the step of providing the communication between levels of groups using communication standards including Message Passing Interface (MPI).

Further, the step of providing intra-group communication includes the step of providing point to point and collective communication using MPI.

Furthermore, the step of providing inter-group communication includes the step of assigning for each processing element in a group at least one peer processing element in another group. It also includes the step of providing point to point and collective communications across groups using MPI.

### BRIEF DESCRIPTION OF THE ACCOMPANYING DRAWINGS

Other aspects of the invention will become apparent by consideration of the accompanying drawings and their description stated below, which is merely illustrative of a preferred embodiment of the invention and does not limit in any way the nature and scope of the invention.

FIG. 1 illustrates a parallel computing system of the prior art randomly solving a problem;

FIG. 2 illustrates an overview of the hierarchical parallel computing system in accordance with this invention;

FIG. 3 illustrates a high level view of the hierarchical parallel computing system in accordance with this invention;

FIG. 4 is a schematic of the hierarchical parallel computing system in accordance with this invention;

FIG. 5 is a flowchart showing the steps for creation of a hierarchical parallel computing system and the communication between processing elements of a hierarchical parallel computing system in accordance with this invention; and

FIG. 6 is a graph showing the processing of data within the groups as proposed in this invention Vs processing of data in the prior the art for parallel computing, with time in seconds required for processing on the Y axis and the size of the data in KB being processed on the X axis.

### DETAILED DESCRIPTION OF THE DRAWINGS

The present invention envisages a system for parallel computing. Particularly, hierarchical parallel computing system which is formed by multiple levels of groups, where each group consists of multiple processing elements. Each group of the parallel computing system models as node to its immediate upper layer. Thus, each node is hierarchically tagged to its immediate upper level, and a multi-level tier of groups are formed.

In accordance with this invention, the parallel computing system operates by breaking any problem hierarchically, first across the groups and then within the groups. This hierarchical breakup of the problem helps in significantly improving the time required for processing a problem.

In accordance with one aspect of this invention, each processing element in the network within a computing system is tagged, hierarchically labeled and collated into groups in accordance with pre-defined parameters. Each group may have sub-groups at its lower level and master-groups at its higher level. Thus, each processing element is hierarchically tagged to its immediate upper level, and a multi-level tier of groups is formed. The exact number of levels/tiers will depend on the actual number of processing elements available and other hardware considerations.

In accordance with another aspect of this invention, the computing system is adapted to break down any input problem into a plurality of smaller problems. The lower levels of groups of processing elements are then employed in accordance with this invention to individually handle the broken down smaller problems in a parallel fashion. The processing elements within the groups are pre-selected in accordance with pre-defined parameters to service portions of said problem.

In accordance with still another aspect of this invention, the parallel computing system is provided by an interconnecting mechanism adapted for connecting one group to another in accordance with pre-defined characteristics and functions. Typically, the communication within a group is more than across the groups. This enables the computing system to take full advantage of grouping which gives rise to much better scalability.

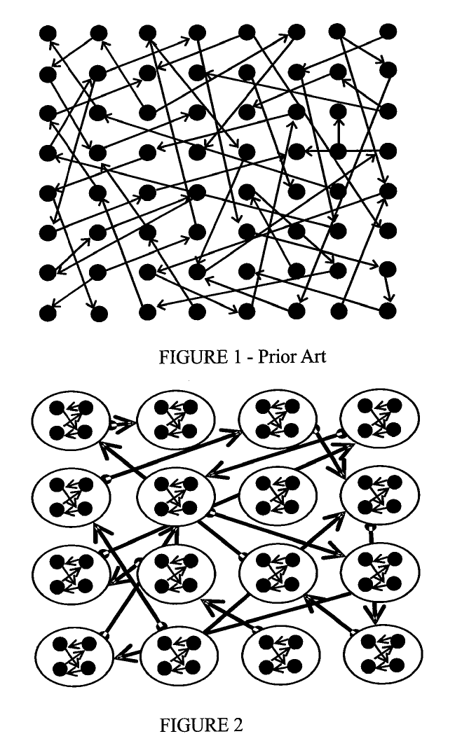

FIG. 2 illustrates an overview of the hierarchical parallel computing system in accordance with this invention.

Here, each group is represented by circles that encircle the set of processing elements represented by dots. The processing elements, although are uniformly shown as dots these are not necessarily similar to each other.

In accordance with the present invention, the problem is first broken amongst the group. At this level the communication between groups is represented by bold arrows. Within each group the group level problems are further subdivided into next lower level groups or divided amongst the processing elements [if it is the last level]. The communication pattern within each group is shown by thin arrows.

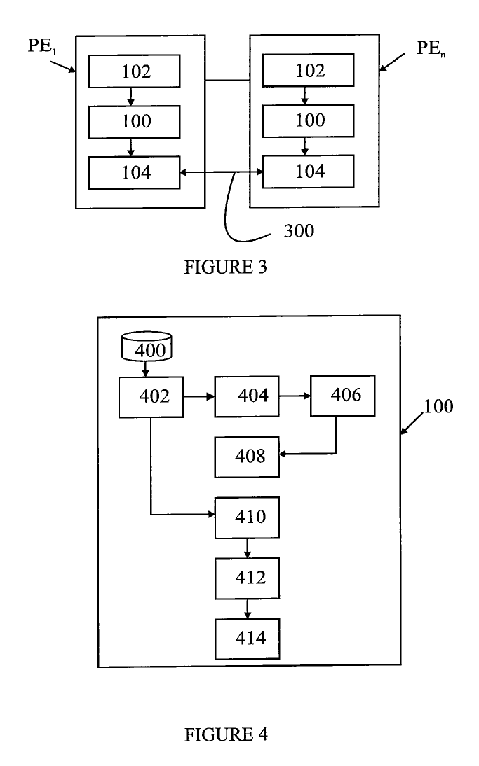

FIG. 3 shows a high level overview of the system for parallel computing, represented by block 100. The system 100 lies between the user application layer 102 and the communication layer 104. The system 100 achieves the intra-group and inter-group communications using the Message Passing Interface (MN) standard of the communication layer. However, this invention can also be implemented on top of other communication standards supported by the communication layer. The system 100 accepts the problem to be solved from the user application 102 and during the initialization stage reads the underlying hardware and network information and forms the hierarchical structure for parallel processing of the problem. The system decides which processing element will liaise with which processing element. Similarly the system decides the communication patterns for the processing elements and the groups. The actual processing spawning and the communications are handled by the communication layer. This invention using the MPI standard for communication as MPI works with different interconnects and connection topologies and is optimized and portable. However, this invention is not bound to MPI. It can be implemented on top of other communication standards as well. The communication layer provides the hardware link/interface 300 between the processing elements of the hierarchical parallel computer.

FIG. 4 is a block diagram for the system 100. The system consists of hierarchical groups of processing elements and a network adapted to connect each of the processing element in a group to at least one other processing element in the group and at least one processing element in a group to at least one other processing element in another group. The grouping of the processing element is based on the “shared hardware resources” and the underlying network topology information which is stored in the storage 400. This stored information is received by the inputting means 402 which acts as an interface for the system. On receiving the input information, the system 100 groups the processing elements/cores that share the same memory together, these are the cores on the same node. Further, the nodes that are connected to the same switch are grouped together as well. The system 100 is given the knowledge of “shared hardware resources” from an input file received by the inputting means 402 via the storage. The input file contains the “shared hardware resource” information for each processing element/node.

In accordance with yet another aspect of the present invention, during the initialization stage, the system reads the input file and finds the respective partners in the groups. Once this information is available the partners form groups using know communication standards like MPI. Thus, the groups encapsulate the hardware information in them. After the groups are formed the communication means 406 can optimally utilize the hardware resource by dividing the communications into intra group and inter group communication.

Furthermore, each element of system is given a distinct identity by the unique identification means 404. Within the groups each processing element is assigned a unique intra-group rank. This facilitates point to point and collective communication within the group using MPI function calls. For inter-group communication each processing element has a peer processing element in other groups, thus all the peer processing element together form the inter-group. Each group in inter-group is given a distinct identity, called inter-group rank. For inter-group communication each processing element in a group talks to its peer processing element in the other group. This is achieved by simultaneous inter-group communication by all the members of the group using the MPI calls via the communication means 406.

Thus, the groups and the inter and intra group communication is independent of the data processing needs and is purely based on the available nodes and the hardware consideration hence the size of the network is only restricted by the hardware. The system envisaged by the present invention gives the flexibility of using all the processing elements at the nodes for intra as well as inter group communication as against the prior art which specifically assigns master and slave nodes where the inter-group communication is only carried out by the master node. This invention is independent of master and slave node arrangements.

In accordance with another aspect of this invention, the system receives the complex problem to be solved via the inputting means 402. The problem is broken down into a plurality of smaller problems typically ‘chunks’ by the distribution means 408. The lower levels of groups of processing elements are employed in accordance with this invention to individually handle the broken down smaller problems in a parallel fashion. The processing elements within the groups are pre-selected in accordance with pre-defined parameters to service portions of said problem. At the end of the processing, the solution chunks of the distributed problem are received by the receiving means 410. The received chunks of the complete solution are collated by the collating means 412 and provided to the user application layer 102 for display.

As, the system is based on the hardware considerations of the network this invention can be implemented on top of any existing parallel computing system and adapts to the existing network topology.

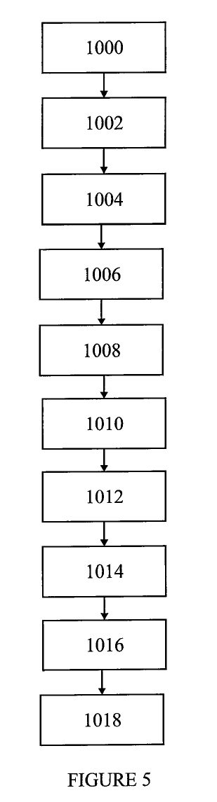

In accordance with the present invention, there is provided a method for parallel computing for solving complex problems, the method comprising the following steps as seen in FIG. 5:
a. creating a hierarchical groups of processing elements, 1000;
b. forming a network adapted to connect each processing elements in a group to at least one other processing element in the group and at least one processing element in a group to at least one other processing element in another group, 1002;
c. assigning a unique intra-group rank to each of said processing elements within the groups and a unique inter-group rank to each of said groups, 1004;
d. providing intra-group and inter-group communication in said network, 1006;
e. storing the ‘shared hardware resource’ information, details of the network topology and the complex problem, 1008;
f. receiving said ‘shared hardware resource’ information, network topology details and the complex problem from said storage means, 1010;
g. distributing said complex problem amongst the groups and the processing elements within the groups for determining a solution by said processing elements, 1012;
h. receiving the solution chunks from said processing elements, 1014; and
i. collating said solution chunks to provide a complete solution for said complex problem, 1016.

### Test Results

A test was conducted using 32 nodes having 256 possessing elements. Using the above setup, two levels of groups were formed and the same amount of data was processed by the system envisaged by the present invention and the prior art parallel computing systems.

TABLE 1
Data values for comparing processing
of data within groups VS prior art.

| | Time for | Time for |
|---|---|---|
| Data (KB) | group (sec) | normal (sec) |
| 39 | 0.78 | 1.84 |
| 390 | 1.94 | 35.9 |
| 3906 | 12.89 | 353.9 |

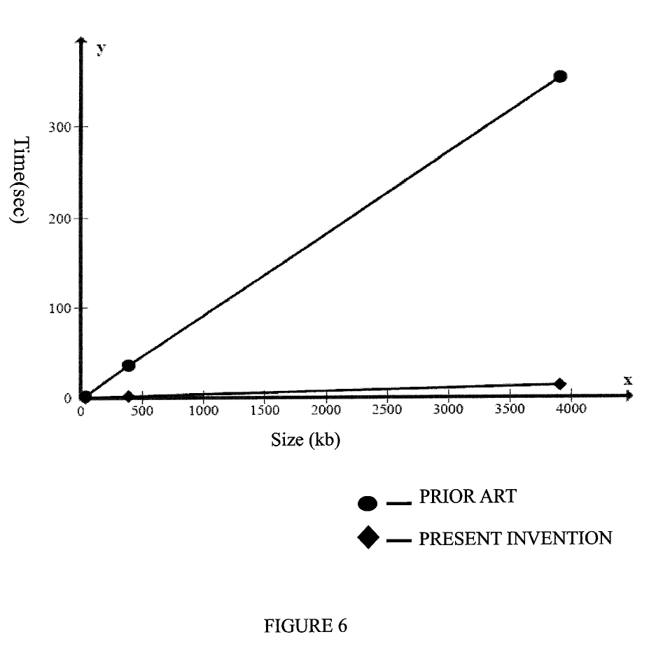

FIG. 6 shows the graph that was plotted for the values seen in TABLE 1 showing the processing of data within the groups Vs processing of data in the prior art for parallel computing, with time in seconds required for processing on the Y axis and the size of the data in KB being processed on the X axis.

The graph shows substantial difference in timings when compared to the random communication pattern of the prior art. Therefore, timing is better if processing elements move more data within the groups and less data across the groups, as proposed by the present invention

### Technical Advantages

The technical advancements of the present invention include in providing a hierarchical parallel computing system which acts as a middle layer between the user application and the communication layer. The hierarchical parallel computing system comprises multiple levels of groups, where each group consists of multiple computing nodes, and each node includes a plurality of processing elements. Each group of the parallel computing system models as node to its immediate upper layer. Thus, each node is hierarchically tagged to its immediate upper level, and a multi-level tier of groups is formed.

In addition, the parallel computing system operates by breaking any problem hierarchically, first across the groups and then within the groups. This hierarchical breakup of the problem helps in significantly improving the time required for processing a problem.

Further, since the hierarchical group structure of the present invention is formed based on the “shared hardware resources” and the underlying network topology the parallel computing system envisaged by the present invention can be easily implemented over any existing parallel computer system with least modification.

Furthermore, the present invention uses MPI communication standard for intra and inter group communication. Each processing element of a group is given a distinct identity/intra group rank within the group, which facilitates point to point and collective communication within the group using the MPI interface. Similarly, for inter group communication each processing element is pre-assigned a peer processing element in another group, thus all peer processing elements together form a inter-group and are identified by a unique inter-group rank. The inter-group communication too takes place using the MPI interface. The intra and inter group arrangements and the unique identification and peer-to-peer communication technique ensures lower levels of congestion in the communication and processing of problems. This facilitates efficient use of the interconnect network.

Particularly, as this invention is independent of the data processing requirements, the size of the groups in only restricted by the available hardware.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

What is claimed is:

1. A system for parallel computing for solving complex problems, said system comprising:
hierarchical groups of processing elements;
network adapted to connect each processing elements in a group to at least one other processing element in the group and at least one processing element in a group to at least one other processing element in another group;
unique identification means adapted to assign a unique intra-group rank to each of said processing elements within the groups and a unique inter-group rank to each of said groups;
communication means adapted to provide intra-group and inter-group communication in said network;
storage means adapted to store the ‘shared hardware resource’ information, details of the network topology and the complex problem;
inputting means adapted to receive said ‘shared hardware resource’ information, network topology details and the complex problem from said storage means;
a distribution means co-operating with the communication means and the inputting means, adapted to distribute said complex problem amongst the groups and the processing elements within the groups for determining a solution by said processing elements;
receiving means adapted to receive the solution chunks from said processing elements; and
collating means adapted to receive and collate said solution chunks and further adapted to provide a complete solution for said complex problem.

2. A system as claimed in claim 1, wherein said communication means is further adapted to provide intra-group communication using point to point and collective communication within the group using Message Passing Interface (MPI).

3. A system as claimed in claim 1, wherein said communication means is still further adapted to provide inter-group communication between each processing element in a group and its peer processing element in another group using MPI.

4. A method for parallel computing for solving complex problems, said method comprising the following steps:
a. creating a hierarchical groups of processing elements;
b. forming a network adapted to connect each processing elements in a group to at least one other processing element in the group and at least one processing element in a group to at least one other processing element in another group;
c. assigning a unique intra-group rank to each of said processing elements within the groups and a unique inter-group rank to each of said groups;
d. providing intra-group and inter-group communication in said network;
e. storing the ‘shared hardware resource’ information, details of the network topology and the complex problem;
f. receiving said ‘shared hardware resource’ information, network topology details and the complex problem from said storage means;
g. distributing said complex problem amongst the groups and the processing elements within the groups for determining a solution by said processing elements;
h. receiving the solution chunks from said processing elements; and
i. collating said solution chunks to provide a complete solution for said complex problem.

5. A method as claimed in claim 4, wherein the step of providing intra-group and inter-group communication includes the step of providing the communication between levels of groups using communication standards including Message Passing Interface (MPI).

6. A method as claimed in claim 4, wherein the step of providing intra-group communication includes the step of providing point to point and collective communication using MPI.

7. A method as claimed in claim 4, wherein the step of providing inter-group communication includes the step of assigning for each processing element in a group at least one peer processing element in another group.
